(19) United States
(12) Patent Application Publication
(10) Pub. No.: US 2009/0061160 A1
(43) Pub. Date: Mar. 5, 2009

(54) Grooved Panel Product and Method

(76) Inventors: Rick Hollin, Columbus, IN (US); Dave Warren, North Vernon, IN (US)

Correspondence Address: JOHN S. PRATT - 38949;KILPATRICK STOCKTON LLP, 1100 PEACHTREE STREET, SUITE 2800, ATLANTA, GA, 30309, US

(21) Appl. No.: 11/847,850

(22) Filed: Aug. 30, 2007

(51) Int. Cl. B32B 3/30

(52) U.S. Cl. 428/163

(57) ABSTRACT

A grooved panel furniture component having plies spaced apart and parallel to one another, giving the appearance of scored wood. The plies are laminated to a substrate that has a solid color that contrasts with the plies. The panel may be cut to any desired size through a die cut process. In one embodiment of the present invention, the panel may be comprised of paperboard that has a decorative paper poly extruded on its visible surfaces. A sheet of the paperboard with the poly extruded decorative paper is cut into plies.

### FIELD OF INVENTION

This invention relates generally to wood paneling components for furniture, and especially for ready to assemble furniture.

### BACKGROUND OF THE INVENTION

There is increasing consumer demand for ready-to-assemble (RTA) furniture, which is furniture sold in component form that the consumer assembles upon purchase. Commonly, components of RTA furniture are composed of wood and wood-derived products, such as particle board. The limited supply of wood for these products had resulted in higher production costs and difficulties in obtaining the material. In addition, solid wood and wood-derived products are not easy to handle or pack, increasing packaging costs.

As the demand for RTA furniture increases, the need for variations also increases. For example, the demand for RTA furniture having a more sophisticated look has increased. Manufacturers have attempted to satisfy this demand with components that have the look and feature of traditional hard wood furniture. Consumer demand for intricately designed components, such as paneling with a Wainscot appearance, has also increased. However, scoring hard wood components is not a cost effective option. Some less costly alternatives, such as using a non-colored bead on a non-wood component, may be used, but lead to a cheapened appearance.

### SUMMARY OF THE INVENTION

Embodiments of the present invention may include a grooved panel for use with RTA furniture and the method of its production. The grooved panel may be produced from a paperboard product. A paperboard product with a poly-extruded wooden grain pattern and color may be slit into a plurality of plies. The plies may be attached to a substrate made of paperboard having a contrasting solid color. The plies may be attached to the substrate with predetermined spacing between the plies, giving the combination a look of a grooved wooden panel. Such a grooved panel may allow a cheaper production of ready to assemble furniture.

Other and alternate features, aspects, and advantages of various embodiments of the present invention, as well as the structure and method of production of various embodiments of the present invention, are described in detail below with reference to the accompanying drawings. Moreover, “embodiment” as used herein can be considered to mean an “aspect” of the invention, and vice versa.

### BRIEF DESCRIPTION OF THE DRAWINGS

FIG. 1 is a top plan view of a panel according to an embodiment of the present invention.

FIG. 2 is a cross-sectional view taken along line 2 of the panel of FIG. 1.

FIG. 3 is a top plan view showing a RTA furniture component comprising a panel according to an embodiment of the present invention.

FIG. 4 is a top plan view of a paperboard sheet according to an embodiment of the present invention.

FIG. 5A is an exploded top plan view of a decorative paper component and a paperboard component according to one embodiment of the present invention.

FIG. 5B is a top plan view of a combination sheet of the paperboard product and the decorative paper of FIG. 5A.

FIG. 6 shows a top plan view of the combination sheet of FIG. 5B prepared for splitting with pattern removed for clarification purposes.

FIG. 7 shows an exploded top plan view of a plurality of panels formed from the combination sheet of FIG. 6.

FIG. 8 shows a top plan view of the spacing of the plurality of panels of FIG. 7.

FIG. 9 shows a top plan view of substrate and the panels of FIG. 7.

FIG. 10 shows a top plan view of the webbing sheet of the substrate and the panels of FIG. 9 with color of substrate removed for clarification purposes.

FIG. 11 shows a top plan view of the webbing sheet of FIG. 10 prepared for sizing.

### DETAILED DESCRIPTION

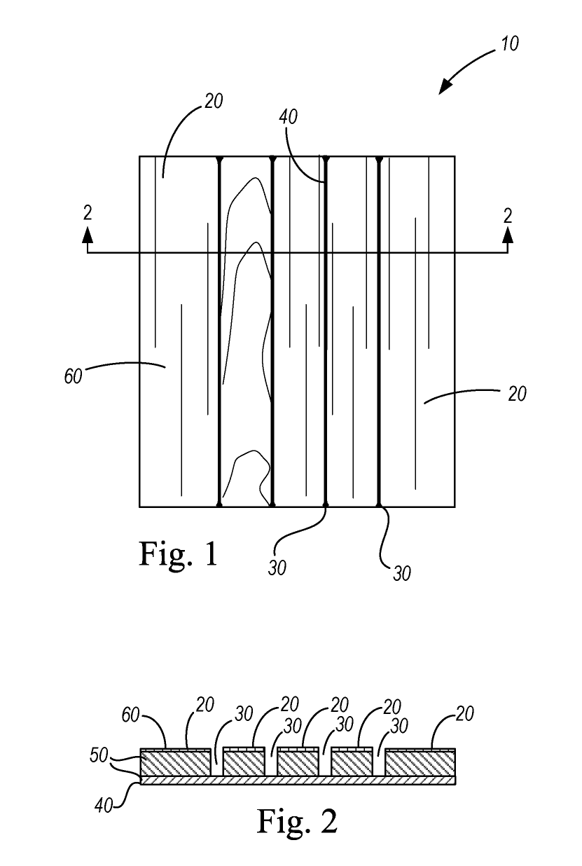

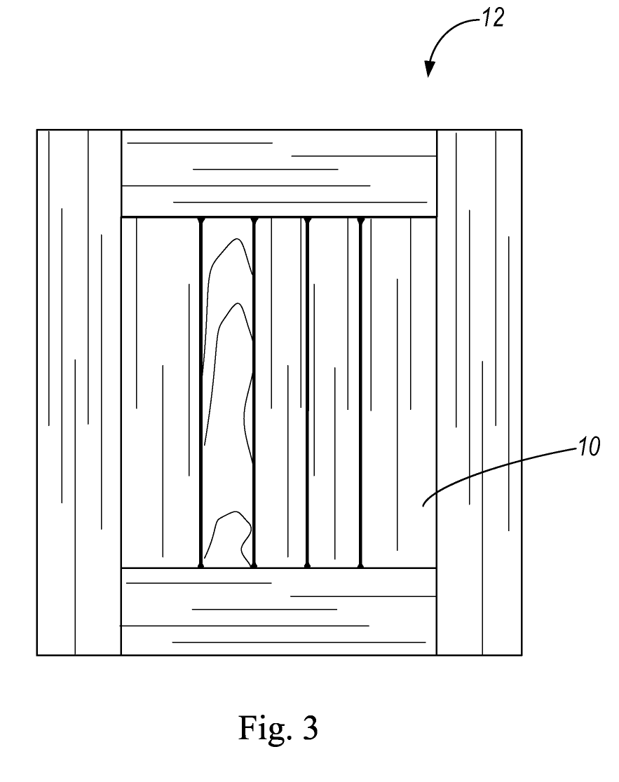

FIGS. 1-2 illustrate a grooved panel 10 according to an embodiment of this invention. The grooved panel 10 may be used in a component 12 for RTA furniture, as shown in FIG. 3, but has uses in other areas as well. The grooved panel 10 may be used as paneling for doors, as a panel 10 for furniture backing, or in any other suitable manner. As shown in FIG. 1, the grooved panel 10 includes a plurality of plies 20 adhered to a substrate 40 and separated by grooves 30. FIG. 2 illustrates a cross-sectional view of the panel 10 along line 2 of FIG. 1. In one embodiment, the plies 20 have a decorative paper 60, featuring a pattern, such as wood grain, adhered to its surface. The plies may be laminated to the substrate 40, but other suitable methods of adhesion may be used. The plies 20 are adhered to the substrate 40 at predetermined intervals, allowing the surface of the substrate 40 to be visible between the plies 20, thereby forming the grooves 30. The grooves 30 enhance the appearance of the panel 10, suggesting it is scored hardwood.

The dimensions of the grooved panel 10 are only limited by its intended use. The size of the grooves 30 may be of any desired width. In one embodiment, the plies 20 are spaced apart from one another within a range of 3/32″ to ¾″ inches. The overall thickness of the panel 10 may also vary depending on the intended use of the panel. Generally, the plies 20 are thicker than the substrate 40; however, the substrate 40 and the plies 10 may be formed from the same roll of paperboard so that their thickness is the same. In one embodiment, the overall thickness of the panel 10 is between 0.04-0.195 inches.

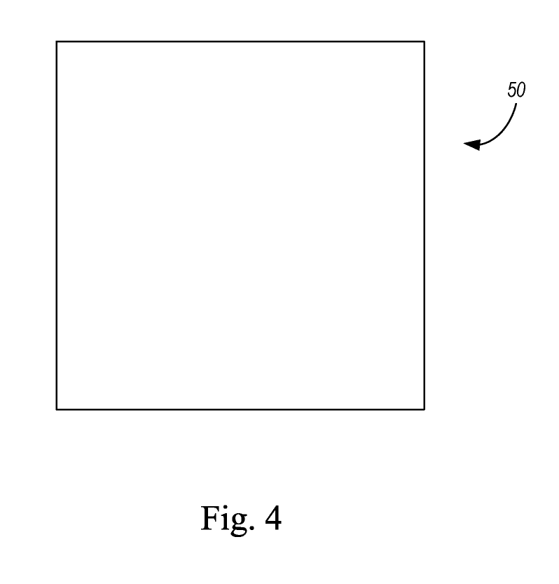

FIG. 4 shows a paperboard sheet 50. The plies 20 and the substrate 40 may be produced from such a paperboard sheet 50, as shown in FIG. 1. Other materials such as, but not limited to, wood substrate or particle board substance may also be used. In some instances, paperboard may be preferable, as it is generally readily available, 100% recyclable and environmentally friendly. In addition, paperboard 50 allows larger portions of panel 10 to be folded, either by scoring along a groove 30, or splitting, but not separating, the plies 20. This folding allows the panel 10 to fit into smaller packaging without jeopardizing the panel's 10 integrity. The combination of theses advantages leads to a reduction in production, packaging, and shipping costs.

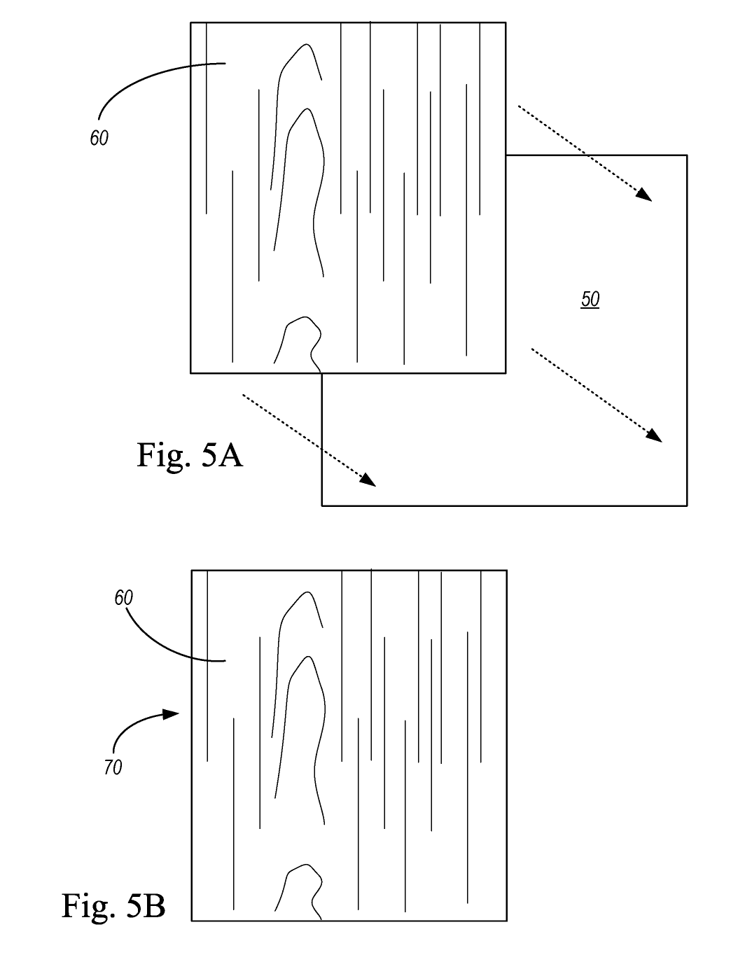

Before the plies 20 and substrate 40 are assembled, and before the plies 20 are formed, a decorative paper 60 may be applied to the paperboard 50 with the decorative paper side up, as shown in FIGS. 5A-5B, forming a combination board 70. The decorative paper 60 may be adhered to the paperboard 50 through poly extrusion or any other suitable method. When the decorative paper 60 is applied, it provides a barrier against moisture. As discussed above, since both the plies 20 and the substrate 40 may be formed from the same paperboard product 50, the combination sheet 70 may be used for either. However, the surface of the combination sheet 70 having the decorative paper 60 becomes the bottom surface if a combination sheet 70 is used as the substrate 40. This may be done when the backside of the panel 10 will be visible. It is also possible for the substrate 40 to be formed from the paperboard 50 without the decorative paper 60 attached.

The decorative paper 60 may have any type of coloring or pattern. In one embodiment, the paper 60 has a wood grain pattern to give the appearance of hardwood furniture. The paperboard 50 used for the substrate 40 may have a color that contrasts with the coloring or pattern of the decorative paper 60 of the combination sheet 70. Portions of the surface of the substrate not covered by the plies 20 will be visible when the plies 40 are attached, forming the grooves 30. The color of the substrate 40 may be solid black, brown, tan, or any other suitable color. This contrast between the color of the plies 20 and the substrate 40 improves the visibility of the grooves 30 of the substrate 40, which contributes to the hardwood appearance of the panel 10.

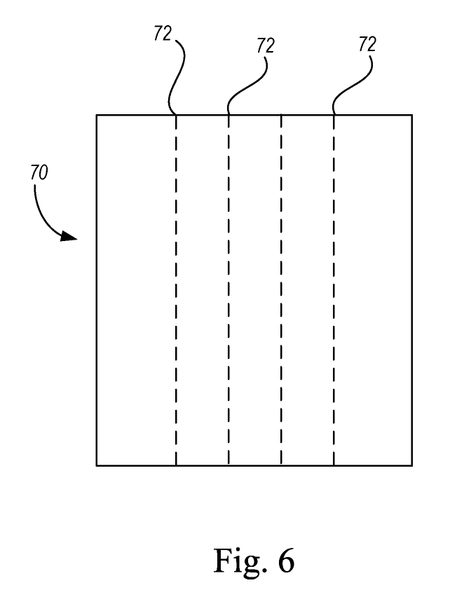

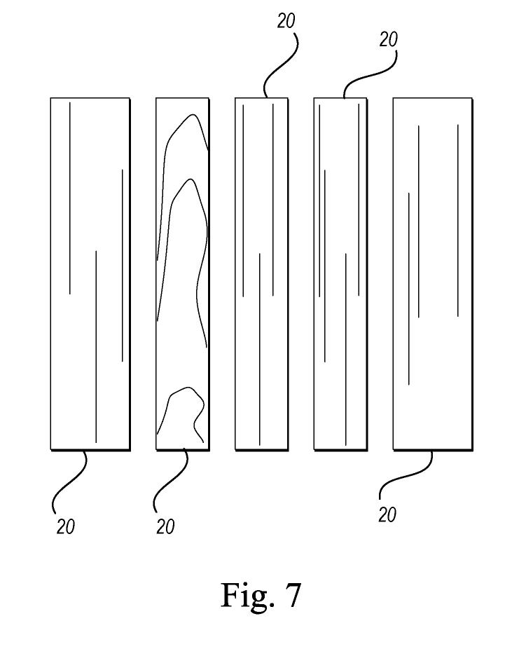

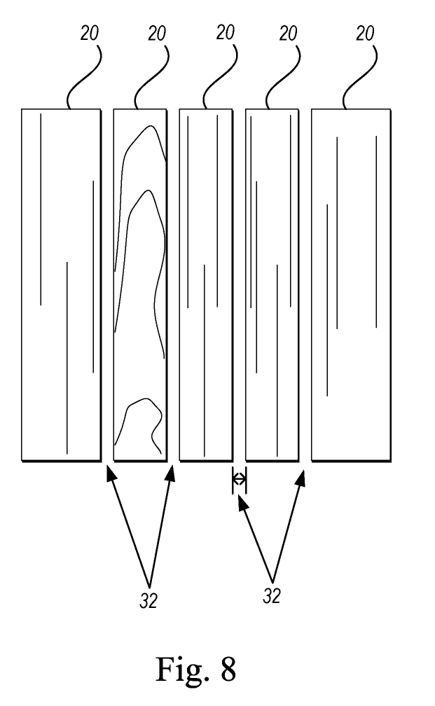

Once the combination sheet 70 has been formed, the plies 20 may be produced. The combination sheet 70 may be divided in plies 20 as shown in FIGS. 6-7. The plies 20 may be created by running the combination sheet 70 through a slitting machine which slits the plies along parallel lines 72. The plies 20 for one panel 10 may be cut to various widths. In one embodiment, the width of the plies is consistent. The combinations sheet 70 may be cut into plies 20 using a slitting machine, or any other suitable method.

After being formed, the plies 20 are spaced apart to a specified distance 32 as shown in FIG. 8. The specified distances 32 may be uniform or vary amongst themselves. A routing plate may separate the plies 20 to the specified distance 32 to form the desired grooves 30 for the panel 10. The routing plate ensures that the plies 20 are spaced apart from one another in a substantially parallel fashion. This further adds to the scored appearance of the panel 10. Other suitable methods may also be used to space apart the plies 20.

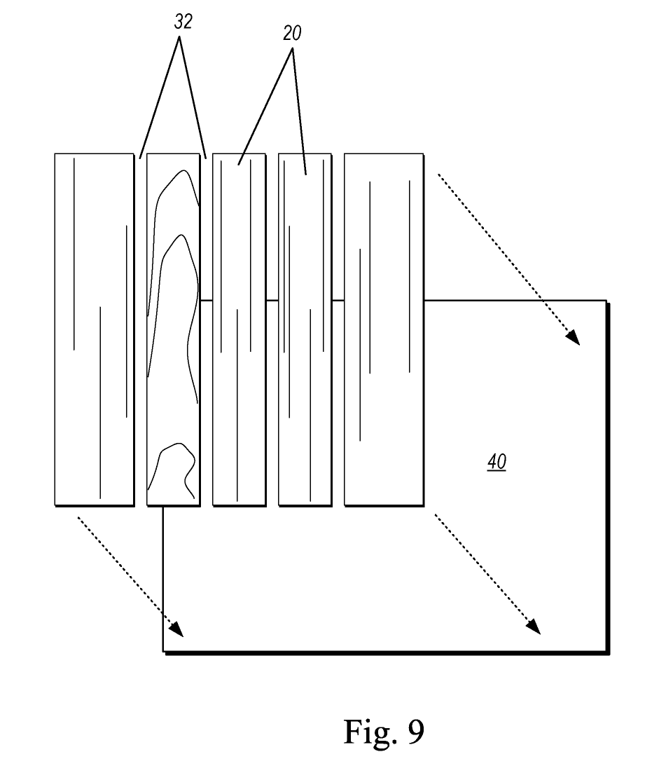

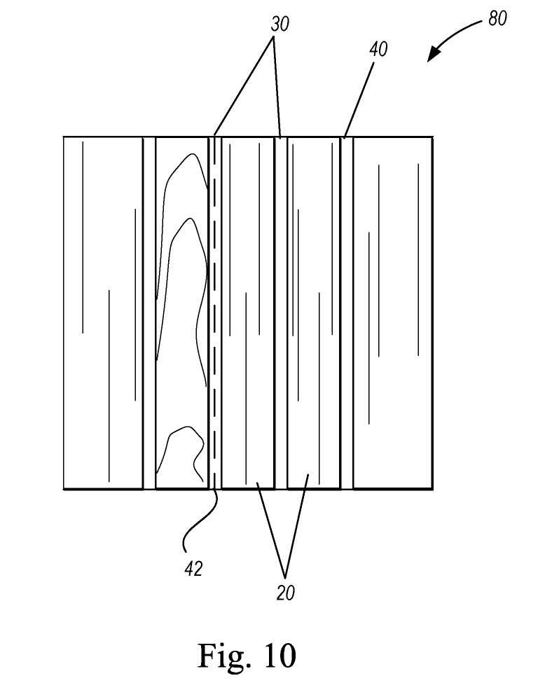

Upon separation, the plies 20, at their specified distance 32, are then attached to the substrate 40, as shown in FIG. 9. In one embodiment, the plies 20 are laminated to the substrate 40 immediately after the plies 20 have been spaced to the specified distance 32 by the routing plate to guarantee a parallel alignment and desired width of the grooves 30. Spray adhesion is one method to attach the plies 20 to the substrate 40. The combination of the plies 20 and the substrate 40 forms a webbing sheet 80 as shown in FIG. 10. However, the plies 20 may be attached to the substrate 40 at a later time. After the grooves 30 have been formed, it is possible to score the substrate 40 along a line 42 within a groove 30 of the webbing sheet 80 as needed, allowing the finished panel to be folded.

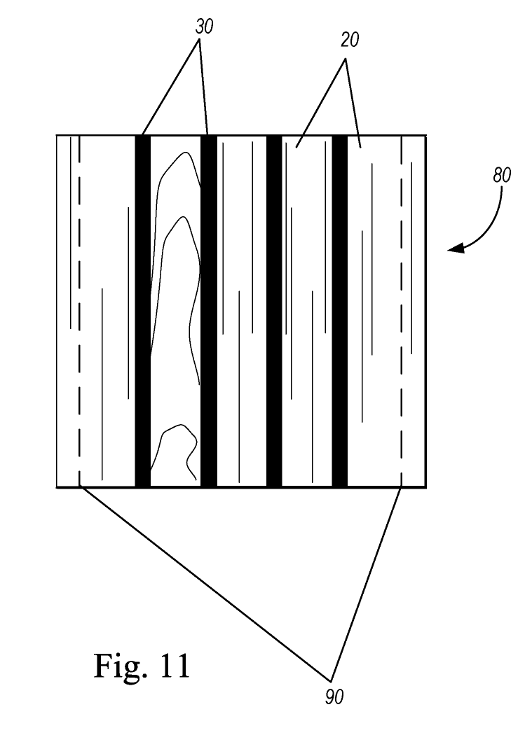

The webbing sheet 80 is then cut to a specified size 90, shown in FIG. 11. The panel 10 may be cut to the size 90 of a cabinet door or a furniture backing. The size corresponds to the intended use. A die cut press may be used to format the size of the webbing sheet 80 to the desired dimensions for the panel 10. However, other methods, such as a slitting machine or table saw, may also be used.

As various modifications could be made in the constructions and methods herein described and illustrated without departing from the scope of the invention, it is intended that all matter contained in the foregoing description or shown in the accompanying drawings shall be interpreted as illustrative rather than limiting. For example, the panel and its method of construction described herein may be altered to be used with particle board or another wood-based component. Thus, the breadth and scope of the present invention should not be limited by any of the above-described exemplary embodiments, but should be defined only in accordance with the following claims appended hereto and their equivalents.

1. A panel component, comprising:
a substrate comprising a top surface, a bottom surface, and a color; and
a plurality of plies, each ply comprising
a top surface comprising a color that contrast with the color of the substrate, and
a bottom surface,
wherein each bottom surface of each of the plurality of plies is attached to the top surface of the substrate and wherein the plurality of plies are spaced apart substantially parallel to one another so that a portion of the top surface of the substrate is visible.

2. The panel component of claim 1, wherein the plurality of plies is formed from a paperboard material.

3. The panel component of claim 1, wherein at least one of the plurality of plies has a wood-grain pattern on the top surface and is attached to the substrate with the top surface visible.

4. The panel component of claim 1, wherein the color of the substrate is selected from a group consisting of brown, black, or tan.

5. The panel component of claim 1, wherein the bottom surface of the substrate has a wood-grain pattern.

6. The panel component of claim 1, wherein a score is formed along a portion of the top surface of the substrate.

7. A panel component, comprising:
(a) a paperboard substrate comprising a color selected from a group consisting of brown, black, or tan; and
(b) a plurality of paperboard plies each ply comprising
(i) a top surface having a wood-grain pattern; and
(ii) a bottom surface attached to the substrate,
wherein the plurality of paperboard plies are spaced apart substantially parallel to one another and are attached to the substrate such that both of the top surface of the plurality of plies and at least a portion of the substrate is visible to form a plurality of grooves.

8. The component panel of claim 7, wherein the plurality of plies are spaced apart between 3/32″ and ¾″ of an inch.

9. The component panel of claim 7, wherein a bottom surface of the substrate has a wood-grained pattern.

10. The method for forming a grooved panel component, comprising:
providing a sheet of paperboard;
poly extruding a decorative paper to the paperboard to form a combination sheet;
creating a plurality of plies from the combination sheet;
spacing the plurality of plies apart; and
adhering the plurality of plies to a substrate.

11. The method of claim 10, wherein adhering the plurality of plies to a substrate further comprises adhering the plurality of plies by laminating the plurality of plies to the substrate.

12. The method of claim 10, wherein creating a plurality of plies further comprises creating a plurality of plies by running the combination sheet through a splitting machine.

13. The method of claim 12, wherein spacing the plurality of plies apart further comprises spacing the plurality of plies apart by running the plurality of plies through a route plate.

14. The method of 10, further comprising providing a substrate made of paperboard material after spacing the plurality of plies apart and before adhering the plurality of plies to the substrate.

15. The method of 14, wherein providing a substrate made of paperboard material further comprises providing a substrate made of paperboard material, wherein a bottom surface of the substrate has a wood-grain pattern.

16. The method of 14, wherein providing a substrate made of paperboard material further comprises providing a substrate made of paperboard material, the substrate being of a solid brown, black, or tan color.

17. A ready to assemble furniture unit having a panel component, the panel component comprising:
(a) a substrate formed from a paperboard material comprising
(i) a color selected from a group consisting of brown, black or tan and
(ii) a bottom surface having a wood-grain pattern; and
(b) a plurality of plies attached to the substrate, the plurality of plies comprising
(i) a paperboard material and
(ii) a wood-grain pattern on a top surface of at least one of the plurality of plies that contrasts with the solid color of the substrate,
wherein the plurality of plies are spaced apart in a substantially parallel manner and adhered to a top surface of the substrate so that the color of the substrate is visible.
